(19) United States
(12) Patent Application Publication
(10) Pub. No.: US 2015/0073990 A1
(43) Pub. Date: Mar. 12, 2015

(54) ELECTRONIC TRANSACTION METHOD

(71) Applicant: MasterCard International Incorporated, Purchase, NY (US)

(72) Inventors: Enrico ALIPRANDI, Lucca (IT); Alessandra GRASSI, Roma (IT); Cary DOWNES, Kent (GB); Michael SASS, Brussels (BE); Jasmine NG, Singapore (SG); Donghao HUANG, Singapore (SG); Stephen TONER, Dublin 9 (IE); Zhiwei ZHOU, Singapore (SG)

(21) Appl. No.: 14/481,100

(22) Filed: Sep. 9, 2014

(30) Foreign Application Priority Data
Sep. 9, 2013 (GB) 1316028.8

(51) Int. Cl. G06Q 20/38; G06Q 20/28; G06Q 20/40

(52) U.S. Cl. CPC G06Q 20/389; G06Q 20/381; G06Q 20/40; G06Q 20/28
USPC 705/44

(57) ABSTRACT

Disclosed herein is a method of transferring information in an electronic transaction between a first entity and a second entity. The method comprises: sending, by a first system 101 of the first entity, information relating to the transaction to an administrating system 102, wherein the information is transferred as a pre-payment operation; transferring by the administrating system 102, in dependence on a determination that the transaction is authorised, the received information from the first system 101 to a second system 103, wherein the second system 103 is a system of the second entity and the information is transferred as a pre-payment operation; wherein, the first system 101 is located in a first country and the second system 103 located in a second country such that the transaction is a cross-border transaction.

### FIELD OF THE INVENTION

The present invention relates to a method for performing electronic transactions. Embodiments of the invention provide a method for performing cross-border and/or cross-currency, electronic transactions that is faster and more secure than possible with known techniques, in Government to anyone (G2), Government to citizen (G2C), business to business (B2B) and business to customer (B2C) environments.

### BACKGROUND OF THE INVENTION

There are a number of known operating models for implementing cross-border transactions between countries. Such payments between countries involve the transfer of funds through local banks. If there are different currencies, a currency conversion is required between the currency of the country of the entity sending money and the currency of the country of the entity receiving the payment.

Although known systems provide the service of transferring money, they are generally not able to provide three or more of the following:
Fast transfer of money. Cross-border transfer of money may take from 6 to 30 days; (except for real time closed loop systems such as Western Union)
Low cost of money transfer. International payments currently cost about [symbol] 15 to [symbol] 30 to transfer [symbol] 500, with fees being charged generally by both the sending and receiving bank.
A clear and defined set of rules managed by the network which all parties of the transaction must abide by—and that provide end-to-end control over the final crediting of money;
Upfront clarity on the exchange rate between currencies;
Global geographical coverage of countries which are able to receive payments (except for OFAC-sanctioned territories) from a single entry point of the payment system;
Flexibility of disbursement. Payment usually occurs in one single modality per chosen system;
Easy operations' management and control procedures; and
Limited exposure to political and currency risk. In known systems, the risk is fully borne either by the sender or by the receiver for the entire time until the payment is credited. This can only be avoided by taking out specific insurance, which is an additional cost, and not always available.

The ability to send money across the world currently depends on bilateral agreements between two or more banks and/or financial transfer agents for each payment destination country to be covered. There is therefore the complication of a large number of agreements being required and, moreover, there is no single bank, or financial transfer agent, providing a single set of rules for the entire transaction operation. Suppose that, in a cross-border transaction, a person in England with an account with an English bank transfers money to a person in China with an account with a Chinese bank. If the person in England wants to know if the person in China has received the money, then the bank in England can only inform him that the money has been sent from the bank in England. The person in England can only determine if the money has been received by the bank in China, and subsequently transferred into the account of the person in China, by the difficult and slow process of directly contacting the bank in China.

A large number of cross-border payments are made by Governments to citizens that live abroad. This may be, for example, to pay pensions or child support. A problem experienced by current techniques for making these payments is that the payments are vulnerable to fraud. Fraudulent activity may result in pension payments being made to people who are dead, or a greater level of child support being paid given the current circumstances.

Accordingly, a number of problems exist with known electronic transaction methods.

### SUMMARY OF THE INVENTION

Embodiments of the invention solve at least some of the above-identified problems.

According to a first aspect of the invention, there is provided a method of transferring information in an electronic transaction between a first entity and a second entity, the method comprising: sending, by a first system of the first entity, information relating to the transaction to an administrating system, wherein the information is transferred as a pre-payment operation; transferring by the administrating system, in dependence on a determination that the transaction is authorised, the received information from the first system to a second system, wherein the second system is a system of the second entity and the information is transferred as a pre-payment operation; wherein, the first system is located in a first country and the second system is located in a second country such that the transaction is a cross-border transaction.

Preferably, the information is stored in the administrative system at a location represented by at least one of: a physical account with a physical account number; a virtual account with a virtual account number; a virtual card with a virtual card number; or a pre-paid primary account, or card, with a pre-paid primary account number, PAN.

Preferably, the information is stored in the second system at a location represented by at least one of: a physical account with a physical account number; a virtual account with a virtual account number; a virtual card with a virtual card number; or a pre-paid primary account, or card, with a pre-paid primary account number, PAN.

Preferably, the method further comprises the administrating system determining the second system for use by the second entity.

Preferably, the administrating system is configured to generate a log of the status of the transaction.

Preferably, the log includes: an indication that the information has been transferred from the first system to the second system; or an indication that the information has not been transferred from the first system to the second system and, optionally, an indication of why the information has not been transferred.

Preferably, the method further comprises generating a unique identifier of the log of the transaction; and transmitting the unique identifier of the log to the first system.

Preferably, the method further comprises: transmitting, by the first system, a request for information on a transaction to the administrating system, wherein the request comprises the unique identifier of the transaction; and sending, by the administrating system, a response to the request in dependence on the information comprised in the log identified by the unique identifier.

Preferably, the information is stored in the second system by a virtual account, the method further comprising transferring the information from the virtual account to a physical account of the second entity.

Preferably, the first system and/or second system is the system of one or more of: a Government, a bank, a Common Global Implementation, CGI, processor, a network of entities, a mobile terminal or an individual person.

Preferably, the administrating system credits the second system through a clearing settlement system.

Preferably, the method further comprises the administrating system determining that the transaction is not authorised in dependence on an indication that the second entity should not be a recipient of the information.

Preferably, the method further comprises the administrating system and/or second system: performing a Know Your Customer, KYC, check; and authorising the transaction in dependence on the KYC check.

Preferably, the method further comprises outputting, by the administrative system, information of one or more transaction logs to a web portal of the administrating system.

Preferably, the method further comprises a device receiving information on a plurality of transaction logs from the webportal; and displaying, by the device, the received information on a plurality of transaction logs from the webportal.

Preferably, the method further comprises the first system uploading a plurality transaction requests as a batch to the administrating system, each transaction request comprising information for transferring between a first entity and another entity.

Preferably, the plurality of transaction requests are uploaded through a webportal of the administrating system.

Preferably, the information is representative of a financial amount.

Preferably, the method further comprises: changing, by the administrating system, the financial amount in dependence on an exchange rate between the currencies of the country of the first system and the country of the second system before the second system receives the information.

According to a second aspect of the invention, there is provided a cross-border transaction system comprising a first system in a first country, an administrating system and a second system in a second country, the system as a whole configured to perform the method of the first aspect of the invention.

### BRIEF DESCRIPTION OF THE DRAWINGS

Embodiments of the invention will now be described, by way of example only, with reference to the accompanying drawings, in which:

FIG. 1 shows an exemplary, schematic system architecture;

FIG. 2 shows an exemplary communications interface;

FIG. 3 shows another exemplary communications interface;

FIG. 4 shows yet another exemplary communications interface; and

FIG. 5 shows a flow chart of a process according to an embodiment of the invention.

### DETAILED DESCRIPTION

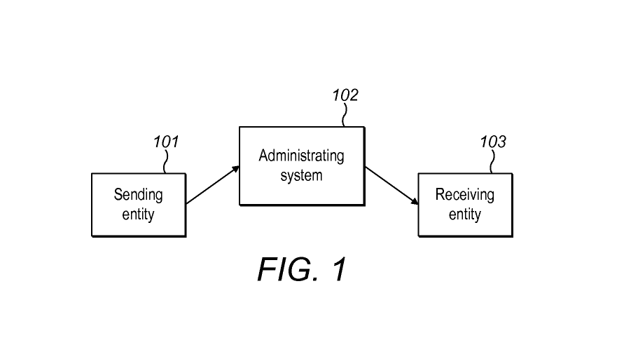

Embodiments of the invention provide a global cross-border and cross-currency funds transfer service that improves on known implementations of electronic transaction methods. The techniques according to embodiments allow money to be transferred across the world in a quick, safe, reliable and transparent way. Embodiments are particularly advantageous for entities such as Governments and Corporations, since those embodiments allow a large number of fast and secure cross-border and cross-currency payments to be made easily to individuals and are therefore useful for disbursing pensions, social benefits and any other payments. A system according to embodiments is shown in FIG. 1. FIG. 1 shows a sending entity 101, a receiving entity 103 and an administrating system 102 arranged between the sending and receiving entities. The sending and receiving entities may both be banks. The administrating system 102 may be a trusted third party intermediary system such as, for example, one operated by MasterCard®. The sending and receiving entities are located in different countries and, if the countries have different currencies, the transfer of money between the banks will require a currency conversion.

In embodiments, the bank of the sending entity 101 transfers money to the receiving entity 103 via the administrating system 102. This differs from known electronic transaction techniques in which the transfer of money is directly from a bank of the sending entity 101 to a bank of the receiving entity 103.

The transfer of money between a sending entity 101 and a receiving entity 103 according to embodiments is described below.

Preferably, the administrating system 102 is used to move funds among credit, debit or pre-paid cards/accounts of the sending and receiving entities, that may be referred to hereinafter as payment accounts. The payment cards/accounts are similar to such pre-paid accounts as used for travel cards or phone cards. The transfer of money to such a pre-paid card/account is therefore similar to the process required to increase the balance on known pre-paid cards/accounts. Each payment is therefore instructed in the same way as that already in use between banks to credit funds onto cards (for instance, from gaming winnings, cash to card reloads, P2P transactions, etc.). The payment accounts differ from, for example, current or savings accounts which are more difficult to set-up and not pre-paid.

The payment cards/accounts may be in a digital/virtual or physical form factor. The transaction is originated by the sending institution which acts like a merchant, in, for example, MasterCard's® messaging system. A physical or virtual payment account (PAN) is set up in the administrating system 102 that the sending entity 101 sends a payment to. A recipient of the payment may have a physical or virtual pre-paid PAN at either a bank of the administrating system's 102 choice in the recipient's country, or the sending entity 101 may provide web based pre-paid PAN operated by a regional or global processor. The administrating system 102 transfers the payment between the PANs of the sending and receiving entities.

If the transaction is between entities in countries with different currencies, the administrating system 102, for example, MasterCard® will perform the necessary conversion between the currencies for the payment.

Accordingly, in embodiments, there is no standing instruction to a bank in order to send a payment. Embodiments only require bank numbers to communicate to each other and the numbers are credited through the administrating system's 102 clearing settlement system.

In addition, the administrating system 102 provides a full set of rules for the transaction. This provides a simpler and more reliable transaction than known electronic transaction techniques not having such an administrating system 102 controlling the transaction, whereby the rules of the known transactions are dependent on the rules of both the sender's and recipient's banks.

The administrating system 102 may be, or use the processes of, for example, MasterCard® systems. For example, a payment may be instructed using a ‘payment to’ message, which is an existing transaction in MasterCard's® messaging format. Flags may be introduced so that the system is able to recognise the transactions. For instance, in B2B payments a specific field will be populated so that the receiving entity 103 can reconcile the financial flow with the invoice.

The receiver may obtain the transferred money in any of a number of forms, sometimes referred to as form factors. For example, if the receiver has chosen to receive the money with a virtual card, the receiver can order a transfer from the virtual card to their current account. Alternatively, if the receiver receives the money from the administrating system 102 on a physical card/account, the money can be withdrawn in cash. The received money need not be transferred to an account of the recipient and may be spent in the same way that money on a pre-paid card can. The receiving entity 103 would preferably be capable of linking to a cash out network, such as post offices.

A particularly preferred feature of embodiments is to maintain a log of each transaction. The log would contain all of the details of a transaction, including how much money has been received by the administrating system 102, whether or not the money has been transferred to the receiving entity's 103 PAN and, if the transfer of money to the receiving entity's 103 PAN was refused, the reason why.

Preferably each log has a unique identifier associated with it that the administrating system 102 would send to the sending entity 101. The sending entity 101 is therefore able to obtain information on the status of a transaction by transmitting the unique identifier of the transaction to the administrating system 102, with the administrating system 102 responding with information from the associated log of the transaction.

A further preferable feature according to an embodiment, is for a communications interface to be provided between the sending entity 101 and the administrating system 102. The communications interface would preferably be provided by a web portal of the administrating system 102. Such a communication between the sending entity 101 and the administrative system allows the sending entity 101 to authorize and originate payments; check their status, and verify any outstanding amounts.

The communications interface is particularly useful for entities such as Governments that send a large number of payments in batches. For example, the Government systems may be integrated with the administrating system 102 through a web interface/portal that allows a Government to:

Initiate multiple time-dependent payments submitted via batch files using transactions that include the amount, currency, sender, receiver, free text, etc.

View payment confirmations and status.

Generate reporting and billing reconciliation.

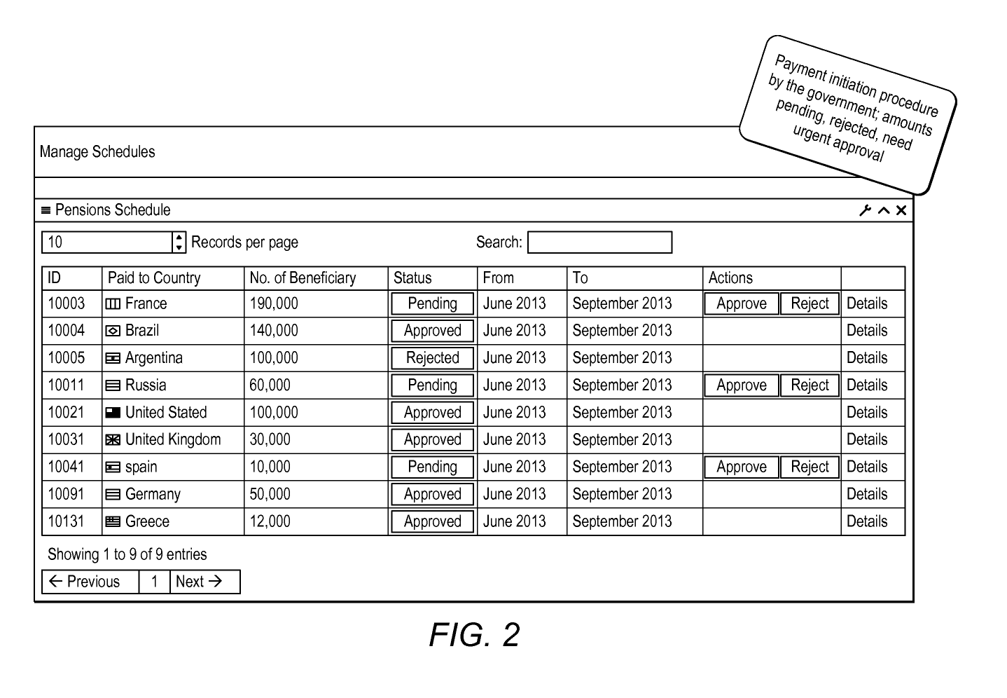

Exemplary screen shots of such interfaces are shown in FIGS. 2 to 4.

An interface such as that shown in FIG. 2 allows the sending entity 101 to initiate payments, view amounts that are pending, have been rejected or need urgent approval.

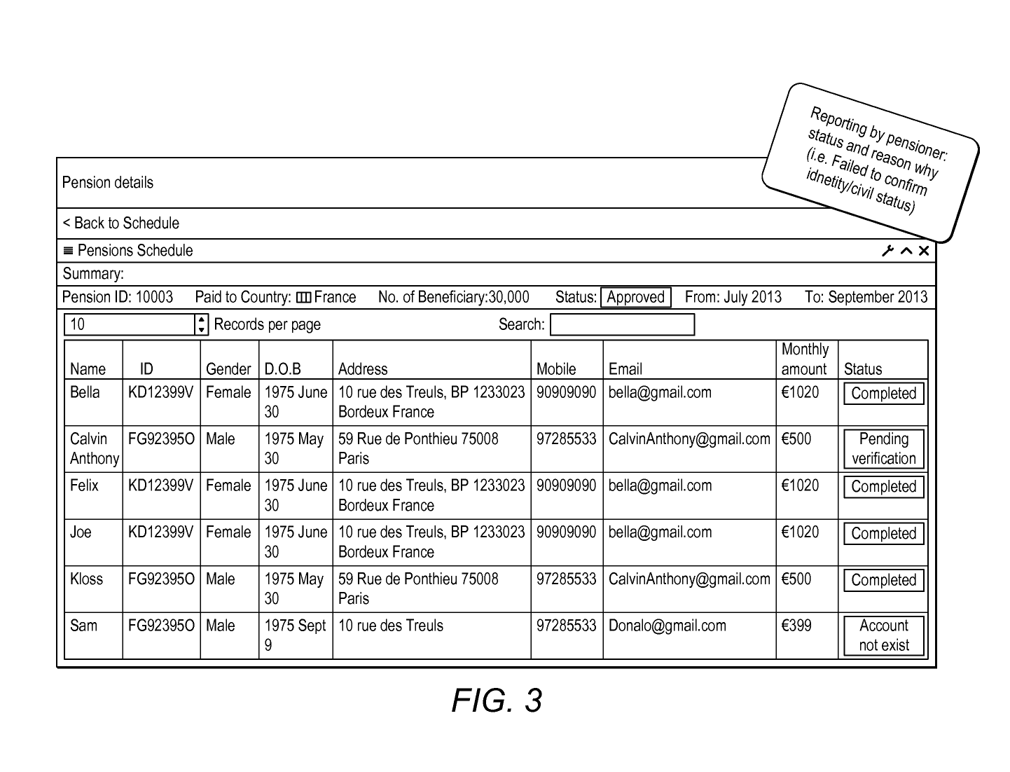

An interface such as that shown in FIG. 3 allows the sending entity 101 to view the statuses of individual pension payments and reasons for why any of the payments have been refused.

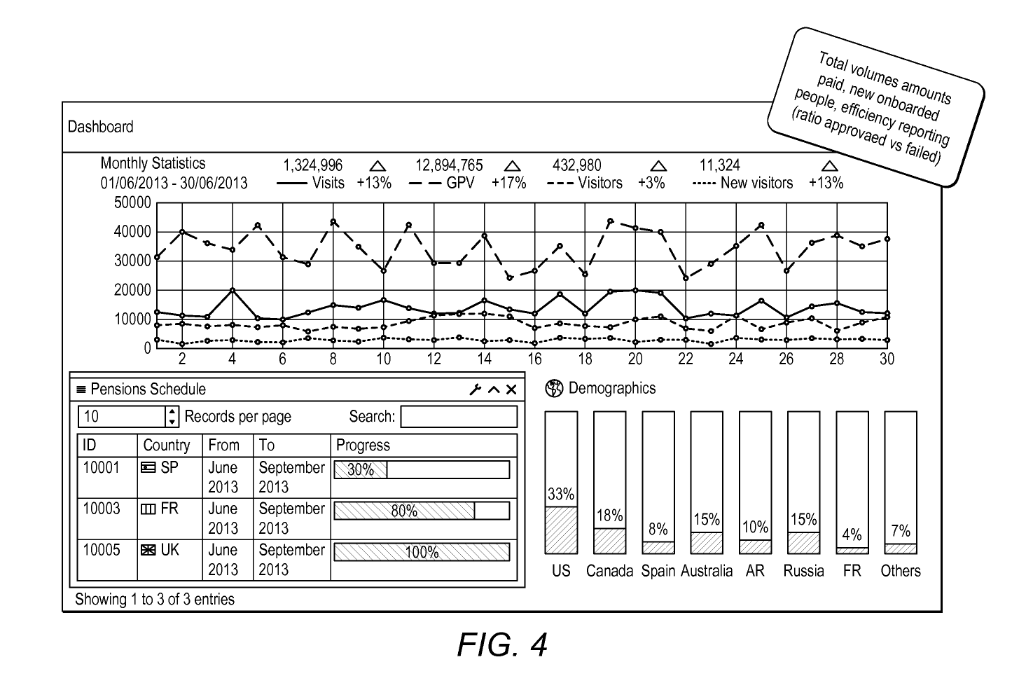

An interface such as that shown in FIG. 4 allows the sending entity 101 to view statistics of the payments, such as the total amounts paid, the number of recipients, approved vs. failed ratios, etc.

Preferably, the administrating system 102 is arranged to process the transaction logs stored therein and output the information, such as through the webportal, in order for a device with sufficient information to generate at least the displays as shown in FIGS. 2 to 4.

A communications interface, such as a web portal, could also be provided to recipients so that they can, for example, manage their account, provide their virtual card number or change the form by which the money is retrieved. Preferably, the communications interface would be accessible from a mobile telephone, for example via an App for a smart phone.

A particularly preferred feature of certain embodiments is for the administrating system 102 only to transfer a payment to the receiving entity's 103 PAN if the transfer of the payment has been authorised, in order to prevent fraudulent payments.

For example, for a pension payment, the authorisation would require obtaining a certification that the recipient was still alive and blocking the pension payment if it was to a person who was dead. Alternatively, for a child allowance payment, the authorisation would involve obtaining a certification that the child was still alive, living at home and below 18 years old, and only transferring the money subject to authorisation. The local bank of the receiving entity 103 could assist with, or entirely perform, the certification of the recipient. The authorisation could use conventional ‘Know Your Customer’, KYC, techniques.

If a transaction is not authorised, the transaction is blocked and no payment is made. The money can be simply returned to the sending entity 101 from the administrating system 102. This is a lot simpler than performing recall of funds procedures, as required for known wire transfers, which are difficult and require a long time.

Although embodiments could be implemented with local banks in each country for the entities, the preferred infrastructure would have the entities supported by regional or, further preferably, global processors. Global payment could be made with regional processors by having a regional processor per region, i.e. one for Asia, one for Europe and Africa, etc. Regional or global processors and settlement banks are preferable since they allow bank numbers to be distributed in a centralised way. The processors and/or banks are also required to move funds and to help perform the KYC checks of the recipients.

Embodiments also include systems that operate as described above but the sending and/or receiving entity 103 alternatively being provided a Common Global Implementation, CGI, bank per region and/or processor for each region, or globally.

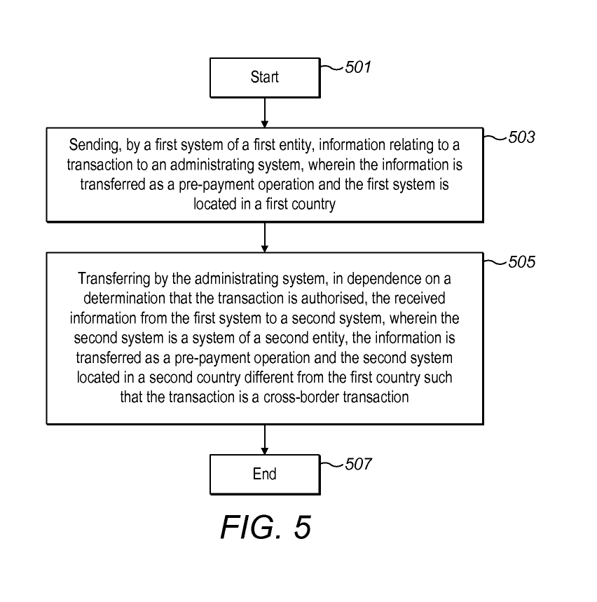

FIG. 5 is a flow chart of an exemplary processes according to an embodiment of the invention.

In step 501 the process begins.

In step 503, the process comprises sending, by a first system 101 of a first entity, information to an administrating system 102, wherein the information is transferred as a pre-payment operation and the first system 101 is located in a first country.

In step 505, the process comprises transferring by the administrating system 102, in dependence on a determination that the transaction is authorised, the received information from the first system 101 to a second system 103, wherein the second system 103 is a system of the second entity, the information is transferred as a pre-payment operation and the second system 103 located in a second country different from the first country such that the transaction is a cross-border transaction.

In step 507, the process ends.

Some of the advantages of electronic transaction techniques according to embodiments are summarised below. Solid, Widespread and Efficient Network:
Clearing in 3 days or less for transactions between any currencies.
Cost reduction compared to known electronic payment techniques.
End-to-end control with payment track management.
Transparency in terms of fees, security, etc. The administrating system 102 is the only entity that the sending entity 101 has to deal with for cross-currency payments.
Local currency settlement and FX management (directly through bank members of local settlement systems)
Solid procedure for rules enforcement and dispute resolution management
Global presence except for OFAC-sanctioned countries
There is no need to have local systems in each country. Only one system per region, or one global system, is required.

Strong Risk Management
The administrating system 102 provides central political and financial risk monitoring, tight management of financial risk, fraud, counterparty risk, regulatory enforcement
The administrating system 102 can manage fraud attacks and regulatory investigations
The administrating system 102 has systematic KYC procedures and controls to ensure that the payment recipient is the actual beneficiary.

Form Factor Agnostic
Payments are possible from, for example, a Government treasury to individual accounts, cash to card, or card to cash
Wire transfers are possible on the initiation or disbursement side
Virtual card to wallet transfers are possible

Flexible Disbursement
Monetary values can be high or low
The transactions may be one-off or recurring

In addition, embodiments avoid the need to issue physical cards and the need to open conventional bank accounts. There is also no need for a funding transaction. In known systems that require a funding transaction, it is necessary to move the funds before payment is instructed and this complicates the structure. Embodiments avoid this as a prepaid account is linked to a settlement account pre-funded by the sender.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of transferring information in an electronic transaction between a first entity and a second entity, the method comprising:
sending, by a first system of the first entity, information relating to the transaction to an administrating system, wherein the information is transferred as a pre-payment operation;
transferring by the administrating system, in dependence on a determination that the transaction is authorised, the received information from the first system to a second system, wherein the second system is a system of the second entity and the information is transferred as a pre-payment operation;
wherein, the first system is located in a first country and the second system is located in a second country such that the transaction is a cross-border transaction.

2. The method of claim 1, wherein the information is stored in the administrative system at a location represented by at least one of:
a physical account with a physical account number;
a virtual account with a virtual account number;
a virtual card with a virtual card number; or
a pre-paid primary account, or card, with a pre-paid primary account number, PAN.

3. The method of claim 1, wherein the information is stored in the second system at a location represented by at least one of:
a physical account with a physical account number;
a virtual account with a virtual account number;
a virtual card with a virtual card number; or
a pre-paid primary account, or card, with a pre-paid primary account number, PAN.

4. The method of claim 1, further comprising the administrating system determining the second system for use by the second entity.

5. The method of claim 1, wherein the administrating system is configured to generate a log of the status of the transaction.

6. The method of claim 5, wherein the log includes:
an indication that the information has been transferred from the first system to the second system; or
an indication that the information has not been transferred from the first system to the second system and, optionally, an indication of why the information has not been transferred.

7. The method of claim 5, further comprising generating a unique identifier of the log of the transaction; and
transmitting the unique identifier of the log to the first system.

8. The method of claim 7, further comprising:
transmitting, by the first system, a request for information on a transaction to the administrating system, wherein the request comprises the unique identifier of the transaction; and
sending, by the administrating system, a response to the request in dependence on the information comprised in the log identified by the unique identifier.

9. The method according to claim 2, wherein the information is stored in the second system by a virtual account, the method further comprising transferring the information from the virtual account to a physical account of the second entity.

10. The method according to claim 1, wherein the first system and/or second system is the system of one or more of: a Government, a bank, a Common Global Implementation, CGI, processor, a network of entities, a mobile terminal or an individual person.

11. The method according to claim 1, wherein the administrating system credits the second system through a clearing settlement system.

12. The method according to claim 1, further comprising the administrating system determining that the transaction is not authorised in dependence on an indication that the second entity should not be a recipient of the information.

13. The method according to claim 1, further comprising the administrating system and/or second system:
performing a Know Your Customer, KYC, check; and
authorising the transaction in dependence on the KYC check.

14. The method according to claim 1, further comprising outputting, by the administrative system, information of one or more transaction logs to a web portal of the administrating system.

15. The method according to claim 14, further comprising a device receiving information on a plurality of transaction logs from the webportal; and
displaying, by the device, the received information on a plurality of transaction logs from the webportal.

16. The method according to claim 1, further comprising the first system uploading a plurality transaction requests as a batch to the administrating system, each transaction request comprising information for transferring between a first entity and another entity.

17. The method according to claim 16, wherein the plurality of transaction requests are uploaded through a webportal of the administrating system.

18. The method according to claim 1, wherein the information is representative of a financial amount.

19. The method according to claim 18, the method further comprising:
changing, by the administrating system, the financial amount in dependence on an exchange rate between the currencies of the country of the first system and the country of the second system before the second system receives the information.

20. A cross-border transaction system comprising a first system in a first country, an administrating system and a second system in a second country, the system as a whole configured to perform the method as set out in claim 1.
